(19) United States
(12) Patent Application Publication
(10) Pub. No.: US 2021/0341295 A1
(43) Pub. Date: Nov. 4, 2021

(54) METHOD AND APPARATUS FOR CONTROLLING VEHICLE

(71) Applicant: BEIJING BAIDU NETCOM SCIENCE AND TECHNOLOGY CO., LTD., Beijing (CN)

(72) Inventors: Yue Wang, Beijing (CN); Ruihao Min, Beijing (CN); Jingjing Xue, Beijing (CN); Yingnan Liu, Beijing (CN); Wenlong Rao, Beijing (CN); Zijie Wang, Beijing (CN); Zelin Wu, Beijing (CN)

(21) Appl. No.: 16/959,276

(22) PCT Filed: Oct. 22, 2019
(86) PCT No.: PCT/CN2019/112542

§ 371 Date: Jun. 30, 2020

(30) Foreign Application Priority Data
Jan. 15, 2019 (CN) 201910037533.X

(51) Int. Cl. G01C 21/34; B60W 60/00; G06Q 50/30

(52) U.S. Cl. CPC G01C 21/343; G06Q 50/30; B60W 60/0025

(57) ABSTRACT

A method and apparatus for controlling a vehicle. An exemplary method includes: acquiring transportation demand information; acquiring driving status information of a vehicle in a vehicle formation; determining a target vehicle from the vehicle formation based on the transportation demand information and the driving status information; and sending a dispatch instruction to the target vehicle, to cause the target vehicle to execute a transportation task indicated by the transportation demand information according to the dispatch instruction.

This patent application claims the priority to Chinese Patent Application No. 201910037533.X, filed on Jan. 15, 2019 by Beijing Baidu Netcom Science and Technology Co., Ltd., entitled “Method and apparatus for controlling vehicle,” the entire disclosure of which is hereby incorporated by reference.

### TECHNICAL FIELD

Embodiments of the present disclosure relate to the field of vehicle control technologies, and specifically to a method and apparatus for controlling a vehicle.

### BACKGROUND

As artificial intelligence technology develops, unmanned vehicles came into being. For an unmanned vehicle traveling on a predetermined route, it is generally dispatched manually in the backend according to the actual application situation. There is currently no effective method to achieve automatic dispatch of the unmanned vehicles.

### SUMMARY

Embodiments of the present disclosure provide a method and apparatus for controlling a vehicle.

In a first aspect, an embodiment of the present disclosure provides a method for controlling a vehicle, including: acquiring transportation demand information; acquiring driving status information of a vehicle in a vehicle formation; determining a target vehicle from the vehicle formation based on the transportation demand information and the driving status information; and sending a dispatch instruction to the target vehicle, to cause the target vehicle to execute a transportation task indicated by the transportation demand information according to the dispatch instruction.

In some embodiments, the vehicle in the vehicle formation travels on a driving route corresponding to the vehicle, and the driving route includes a plurality of stations; and the acquiring transportation demand information, includes: acquiring a number of to-be-transported objects at each station in the driving route, for the driving route corresponding to the vehicle in the vehicle formation; determining the transportation demand information, based on the acquired number of to-be-transported objects.

In some embodiments, the transportation demand information includes the driving route, and the driving status information includes a number of currently transported objects of the vehicle; and the determining a target vehicle from the vehicle formation based on the transportation demand information and the driving status information, includes: determining a vehicle whose number of currently transported objects in the vehicle formation being less than a first preset threshold as a pending vehicle; determining whether a driving route corresponding to the pending vehicle matches the driving route in the transportation demand information; and determining, in response to determining that the driving route corresponding to the pending vehicle matches the driving route in the transportation demand information, the target vehicle from the pending vehicle.

In some embodiments, the transportation demand information includes a driving route, and the driving status information includes location information; and the determining a target vehicle from the vehicle formation based on the transportation demand information and the driving status information, includes: determining, based on the driving route in the transportation demand information and the location information of the vehicle in the vehicle formation, at least one vehicle corresponding to the location information having a shortest distance to the driving route that is less than a second preset threshold; and determining the target vehicle from the determined at least one vehicle.

In some embodiments, the method further includes: acquiring driving environment information of the vehicle in the vehicle formation; and the determining a target vehicle from the vehicle formation based on the transportation demand information and the driving status information, includes: determining the target vehicle from the vehicle formation based on the transportation demand information, the driving status information, and the acquired driving environment information.

In a second aspect, an embodiment of the present disclosure provides an apparatus for controlling a vehicle, including: a first acquisition unit, configured to acquire transportation demand information; a second acquisition unit, configured to acquire driving status information of a vehicle in a vehicle formation; a vehicle determining unit, configured to determine a target vehicle from the vehicle formation based on the transportation demand information and the driving status information; and an instruction sending unit, configured to send a dispatch instruction to the target vehicle, to cause the target vehicle execute a transportation task indicated by the transportation demand information according to the dispatch instruction.

In some embodiments, the vehicle in the vehicle formation travels on a driving route corresponding to the vehicle, and the driving route includes a plurality of stations; and the first acquisition unit includes: a number determining module, configured to acquire a number of to-be-transported objects at each station in the driving route, for the driving route corresponding to the vehicle in the vehicle formation; a demand determining module, configured to determine the transportation demand information, based on the acquired number of to-be-transported objects.

In some embodiments, the transportation demand information includes the driving route, and the driving status information includes a number of currently transported objects of the vehicle; and the vehicle determining unit is further configured to: determine a vehicle whose number of currently transported objects in the vehicle formation being less than a first preset threshold as a pending vehicle; determine whether a driving route corresponding to the pending vehicle matches the driving route in the transportation demand information; and determine, in response to determining that the driving route corresponding to the pending vehicle matches the driving route in the transportation demand information, the target vehicle from the pending vehicle.

In some embodiments, the transportation demand information includes a driving route, and the driving status information includes location information; and the vehicle determining unit is further configured to: determine, based on the driving route in the transportation demand information and the location information of the vehicle in the vehicle formation, at least one vehicle corresponding to the location information having a shortest distance to the driving route that is less than a second preset threshold; and determine the target vehicle from the determined at least one vehicle.

In some embodiments, the apparatus further includes: a third acquisition unit, configured to acquire driving environment information of the vehicle in the vehicle formation; and the vehicle determining unit is further configured to: determine the target vehicle from the vehicle formation based on the transportation demand information, the driving status information, and the acquired driving environment information.

In a third aspect, an embodiment of the present disclosure provides a server, including: one or more processors; and a storage apparatus, storing one or more programs thereon, the one or more programs, when executed by the one or more processors, cause the one or more processors to implement the method according to any embodiment in the first aspect.

In a fourth aspect, an embodiment of the present disclosure provides a computer readable medium, storing a computer program thereon, the program, when executed by a processor, implements the method according to any embodiment in the first aspect.

The method and apparatus for controlling a vehicle provided by the above embodiments of the present disclose, first may acquire transportation demand information, and also acquire driving status information of a vehicle in a vehicle formation, then determine a target vehicle from the vehicle formation based on the transportation demand information and the driving status information, and finally send a dispatch instruction to the target vehicle, so that the target vehicle executes a transportation task indicated by the transportation demand information according to the dispatch instruction. The method of the embodiments implements automatic dispatch of a vehicle in a vehicle formation based on the transportation demand information and the driving status information, thereby improving vehicle use efficiency.

### BRIEF DESCRIPTION OF THE DRAWINGS

By reading the detailed description of non-limiting embodiments with reference to the following accompanying drawings, other features, objectives and advantages of the present disclosure will become more apparent.

FIG. 1 is a diagram of an exemplary system architecture in which an embodiment of the present disclosure may be implemented;

FIG. 2 is a flowchart of a method for controlling a vehicle according to an embodiment of the present disclosure;

FIG. 3 is a schematic diagram of an application scenario of the method for controlling a vehicle according to an embodiment of the present disclosure;

FIG. 4 is a flowchart of the method for controlling a vehicle according to another embodiment of the present disclosure;

FIG. 5 is a schematic structural diagram of an apparatus for controlling a vehicle according to an embodiment of the present disclosure; and

FIG. 6 is a schematic structural diagram of a computer system adapted to implement a server according to an embodiment of the present disclosure.

### DETAILED DESCRIPTION OF EMBODIMENTS

The present disclosure will be further described below in detail in combination with accompanying drawings and embodiments. It may be appreciated that the specific embodiments described herein are merely used for explaining the relevant disclosure, rather than limiting the disclosure. In addition, it should also be noted that, for the ease of description, only the parts related to the relevant disclosure are shown in the accompanying drawings.

It should be noted that the embodiments in the present disclosure and the features in the embodiments may be combined with each other on a non-conflict basis. The present disclosure will be described below in detail with reference to the accompanying drawings and in combination with the embodiments.

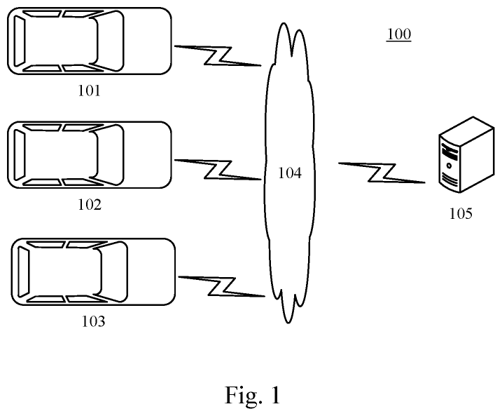

FIG. 1 illustrates an exemplary system architecture 100 in which a method for controlling a vehicle or an apparatus for controlling a vehicle of an embodiment of the present disclosure may be implemented.

As shown in FIG. 1, the system architecture 100 may include vehicles 101, 102, 103, a network 104, and a server 105. The network 104 is used to provide a communication link medium between the vehicles 101, 102, 103 and the server 105. The network 104 may include various types of connections, such as wired, wireless communication links, or optic fibers.

The vehicles 101, 102, 103 interact with the server 105 through the network 104, to receive or send signals and the like. Various electronic apparatuses may be installed on the vehicles 101, 102, 103, such as an image acquisition apparatus, a sensor, and a vehicle controller. The above sensors may be used to acquire environmental data outside the vehicles 101, 102, 103, and the above environmental data may be used as map data for making a map.

The vehicles 101, 102, 103 may be various vehicles, including but not limited to large passenger cars, tractors, city buses, medium passenger cars, large trucks, small cars, small automatic transmission cars, autonomous vehicles, or other smart vehicles.

The server 105 may be a server that provides various services, such as a backend server that determines a road section acquired by the vehicles 101, 102, and 103. The backend server may process a target road section after receiving a map data acquisition instruction, and feedback a processing result (such as a sub road section) to the vehicles 101, 102, and 103.

It should be noted that the server 105 may be hardware or software. When the server 105 is hardware, it may be implemented as a distributed server cluster composed of a plurality of servers, or may be implemented as a single server. When the server 105 is software, it may be implemented as a plurality of software or software modules (for example, for providing distributed services), or as a single software or software module, which is not specifically limited herein.

It should be noted that the method for controlling a vehicle provided by embodiments of the present disclosure is generally performed by the server 105. Accordingly, the apparatus for controlling a vehicle is generally provided in the server 105.

It should be understood that the number of vehicles, networks, and servers in FIG. 1 is merely illustrative. Depending on the implementation needs, there may be any number of vehicles, networks, and servers.

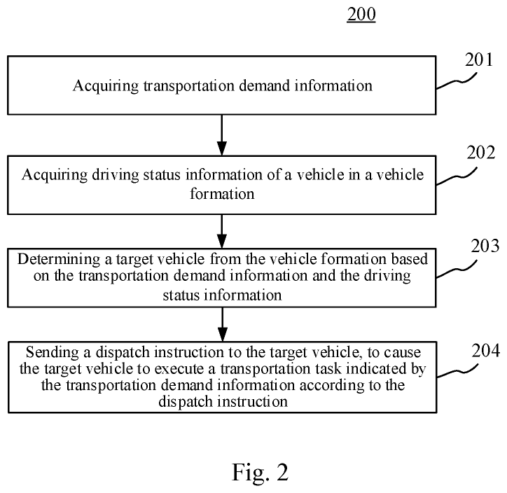

With further reference to FIG. 2, a flow 200 of a method for controlling a vehicle according to an embodiment of the present disclosure is illustrated. The method for controlling a vehicle of the present embodiment includes the following steps.

Step 201, acquiring transportation demand information.

In the present embodiment, an executing body of the method for controlling a vehicle (for example, the server 105 shown in FIG. 1) may acquire the transportation demand information through a wired connection or a wireless connection. The executing body may acquire the transportation demand information from other equipment, or may automatically generate the transportation demand information based on other information. The transportation demand information may be used to indicate a transportation task, which may include, but is not limited to, a transportation starting point, a transportation ending point, a transportation route, and a transportation object.

It should be noted that the above wireless connection may include, but is not limited to, 3G/4G connection, Wi-Fi connection, Bluetooth connection, WiMAX connection, Zigbee connection, UWB (ultra wideband) connection, and other wireless connection methods now known or to be developed in the future.

In some alternative implementations of the present embodiment, a vehicle in a vehicle formation travels on a driving route corresponding to the vehicle, and the driving route includes a plurality of stations. The above step 201 may be specifically implemented through steps not shown in FIG. 2: acquiring the number of to-be-transported objects at each station in the driving route, for the driving route corresponding to the vehicle in the vehicle formation; determining the transportation demand information, based on the acquired number of to-be-transported objects.

In the present implementation, each vehicle in the vehicle formation travels on the driving route corresponding to the vehicle. Each driving route may include a plurality of stations, and the to-be-transported objects may include passengers and goods. The passengers may wait for the vehicle at the station, and the goods may be placed at the station waiting to be loaded. The executing body may first acquire the number of the to-be-transported objects at each station in each driving route. Then, the executing body may determine the transportation demand information, based on the acquired number of the to-be-transported objects. For example, the executing body may add up the numbers of the to-be-transported objects at the stations. When it is determined that the sum is greater than a preset threshold, the transportation demand information of the driving route is generated, and the generated transportation demand information is used to indicate that the driving route needs to dispatch an additional vehicle to travel to transport the to-be-transported objects.

Step 202, acquiring driving status information of a vehicle in a vehicle formation.

In the present embodiment, the vehicle formation may be a formation composed of a plurality of vehicles. The vehicles may be unmanned vehicles, vans, or the like. The driving status information may be information used to represent the driving status of the vehicle, and may include speed, location, objects transported in the vehicle, number of objects transported in the vehicle, or the like. The executing body may acquire the driving status information of the vehicle in the vehicle formation using various methods. For example, the driving status information may be acquired by a sensor or an image acquisition apparatus installed in the vehicle.

Step 203, determining a target vehicle from the vehicle formation based on the transportation demand information and the driving status information.

After acquiring the transportation demand information and the driving status information, the executing body may determine the target vehicle from the vehicle formation. For example, the transportation demand information may include a transportation starting point, a transportation route, or the like. The executing body may determine a vehicle closest to the transportation starting point in the transportation demand information as the target vehicle based on the locations of vehicles in the vehicle formation. Alternatively, the executing body may determine, based on the driving trajectories of vehicles in the vehicle formation, that the vehicle most closely matching the transportation route in the transportation demand information is the target vehicle.

In some alternative implementations of the present embodiment, the transportation demand information includes the driving route, and the driving status information includes the number of currently transported objects of the vehicle. The above step 203 may be specifically implemented by the following steps not shown in FIG. 2: determining a vehicle whose number of currently transported objects in the vehicle formation being less than a first preset threshold as a pending vehicle; determining whether a driving route corresponding to the pending vehicle matches the driving route in the transportation demand information; and determining, in response to determining that the driving route corresponding to the pending vehicle matches the driving route in the transportation demand information, the target vehicle from the pending vehicle.

In the present implementation, the transportation demand information may include the driving route, and the driving status information may include the number of currently transported objects of the vehicle. The transported objects may be passengers, goods, or the like. The executing body may first determine the number of currently transported objects of each vehicle in the vehicle formation, then determine whether each number is less than the first preset threshold. The executing body may determine the vehicle whose number of currently transported objects being less than the first preset threshold as the pending vehicle. The executing body may further determine whether the driving route corresponding to the pending vehicle matches the transportation route in the transportation demand information. Here, matching may mean that the driving route is the same as or partially the same as the transportation route. If the driving route corresponding to the pending vehicle matches the transportation route in the transportation demand information, the executing body may select the target vehicle from the pending vehicle.

In some alternative implementations of the present embodiment, the transportation demand information includes a driving route, and the driving status information includes location information. The above step 203 may be specifically implemented by the following steps not shown in FIG. 2: determining, based on the driving route in the transportation demand information and the location information of the vehicle in the vehicle formation, at least one vehicle corresponding to the location information having a shortest distance to the driving route that is less than a second preset threshold; and determining the target vehicle from the determined at least one vehicle.

In the present implementation, the transportation demand information may include the driving route, and the driving status information may include the location information. The executing body may determine, based on the driving route and the location information of each vehicle, at least one piece of location information having the shortest distance to the driving route that is less than the second preset threshold, then, determine at least one vehicle corresponding to the at least one piece of location information, and finally determine the target vehicle from the at least one vehicle. Specifically, the executing body may determine, from the at least one vehicle, that the vehicle having the least number of currently transported objects is the target vehicle.

Step 204, sending a dispatch instruction to the target vehicle, to cause the target vehicle to execute a transportation task indicated by the transportation demand information according to the dispatch instruction.

After determining the target vehicle, the executing body may send the dispatch instruction to the target vehicle. After receiving the dispatch instruction, the target vehicle may execute the transportation task indicated by the transportation demand information. Specifically, the target vehicle may travel on the transportation route in the transportation demand information to transport the objects.

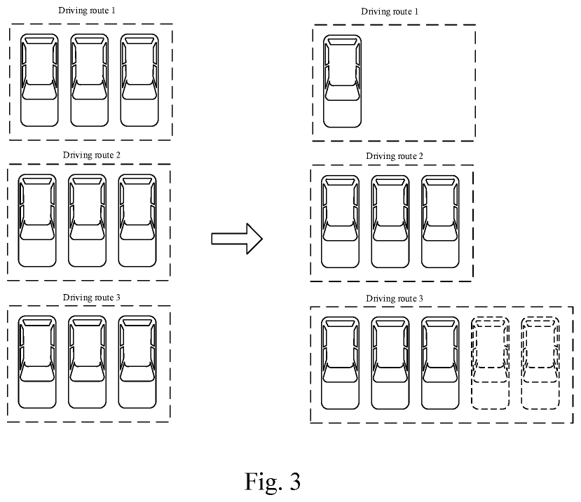

With further reference to FIG. 3, FIG. 3 is a schematic diagram of an application scenario of the method for controlling a vehicle according to an embodiment of the present embodiment. In the application scenario of FIG. 3, unmanned vehicles in an unmanned vehicle formation follow driving routes corresponding to the unmanned vehicles. As shown in FIG. 3, the driving routes include a driving route 1, a driving route 2, and a driving route 3. Each driving route corresponds to 3 unmanned vehicles. Each driving route includes a plurality of stations (not shown in the figure). A cloud management platform acquires the number of people waiting at the stations in the driving route in real time. Once it is determined that the number of people waiting in the driving route 3 exceeds 30, the cloud management platform determines that the transportation demand information is the driving route 3. At the same time, the cloud management platform determines that the number of people waiting in the driving route 1 is less than 5, then uses two unmanned vehicles traveling on the driving route 1 as targeted vehicles, and sends dispatch instructions to the two unmanned vehicles, so that the two unmanned vehicles travel on the driving route 3.

The method for controlling a vehicle provided by the above embodiment of the present disclose, first may acquire transportation demand information, and also acquire driving status information of a vehicle in a vehicle formation, then determine a target vehicle from the vehicle formation based on the transportation demand information and the driving status information, and finally send a dispatch instruction to the target vehicle, so that the target vehicle executes a transportation task indicated by the transportation demand information according to the dispatch instruction. The method of the present embodiment implements automatic dispatch of a vehicle in a vehicle formation based on the transportation demand information and the driving status information, thereby improving vehicle use efficiency.

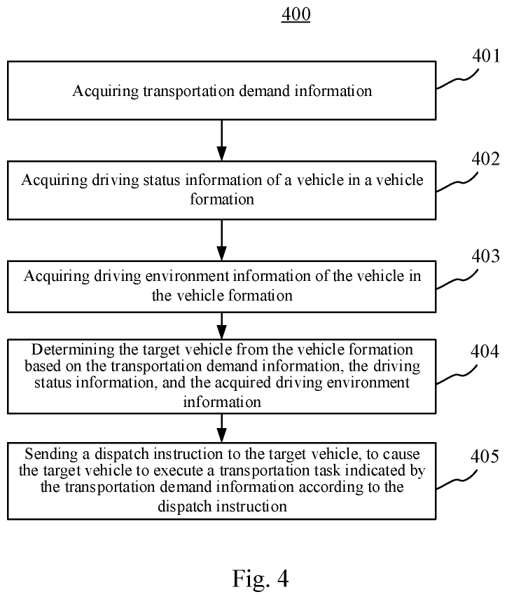

With further reference to FIG. 4, a flow 400 of the method for controlling a vehicle according to another embodiment of the present disclosure is illustrated. As shown in FIG. 4, the method of the present embodiment includes the following steps.

Step 401, acquiring transportation demand information.

Step 402, acquiring driving status information of a vehicle in a vehicle formation.

In the present embodiment, the principle of steps 401 to 402 is similar to the principle of steps 201 to 202, and detailed description thereof will be omitted.

Step 403, acquiring driving environment information of the vehicle in the vehicle formation.

In the present embodiment, the vehicle in the vehicle formation may also be installed with various acquisition apparatuses to acquire the driving environment information of the vehicle. The above acquisition apparatus may include a radar sensor, a binocular camera, or the like. The driving environment information may include traffic light information, obstacle information, lane line information, or the like.

Step 404, determining the target vehicle from the vehicle formation based on the transportation demand information, the driving status information, and the acquired driving environment information.

In the present embodiment, the executing body may determine the target vehicle from the vehicle formation based on the transportation demand information, the driving status information, and the driving environment information of the vehicles. Specifically, the executing body may determine whether the current road section of the vehicle is congested based on the driving environment information. Further, the executing body may select the target vehicle from vehicles that are not congested on the road sections based on the transportation demand information and the driving status information. Alternatively, the executing body may determine the congestion of the road sections based on the driving environment information of the vehicles. Then, the transportation route is divided into a plurality of transportation sub-tasks based on the congestion of the road sections and the transportation route included in the transportation demand information. Finally, a plurality of target vehicles corresponding to the transportation sub-tasks are determined from the vehicle formation, so that the plurality of target vehicles respectively perform the transportation sub-tasks.

Step 405, sending a dispatch instruction to the target vehicle, to cause the target vehicle to execute a transportation task indicated by the transportation demand information according to the dispatch instruction.

Finally, the executing body may send the dispatch instruction to the target vehicle. After receiving the dispatch instruction, the target vehicle may execute the transportation task indicated by the transportation demand information.

The method for controlling a vehicle provided by the above embodiment of the present disclosure may send the dispatch instruction to the target vehicle in the vehicle formation combining the driving environment information of the vehicles, thereby enabling more flexible dispatch of the vehicle.

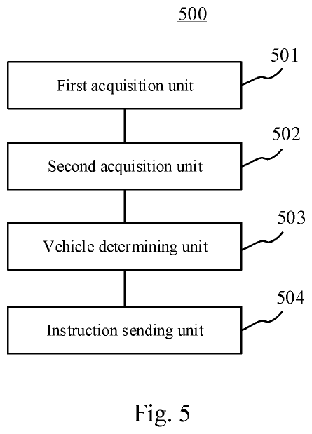

With further reference to FIG. 5, as an implementation of the method shown in the above figures, an embodiment of the present disclosure provides an apparatus for controlling a vehicle, and the apparatus embodiment corresponds to the method embodiment as shown in FIG. 2, and the apparatus may be specifically applied to various electronic devices.

As shown in FIG. 5, an apparatus 500 for controlling a vehicle of the present embodiment includes: a first acquisition unit 501, a second acquisition unit 502, a vehicle determining unit 503, and an instruction sending unit 504.

The first acquisition unit 501 is configured to acquire transportation demand information.

The second acquisition unit 502 is configured to acquire driving status information of a vehicle in a vehicle formation.

The vehicle determining unit 503 is configured to determine a target vehicle from the vehicle formation based on the transportation demand information and the driving status information.

The instruction sending unit 504 is configured to send a dispatch instruction to the target vehicle, to cause the target vehicle to execute a transportation task indicated by the transportation demand information according to the dispatch instruction.

In some alternative implementations of the present embodiment, the vehicle in the vehicle formation travels on a driving route corresponding to the vehicle, and the driving route includes a plurality of stations. The first acquisition unit 501 may further include a number determining module and a demand determining module not shown in FIG. 5.

The number determining module is configured to acquire the number of to-be-transported objects at each station in the driving route, for the driving route corresponding to the vehicle in the vehicle formation.

The demand determining module is configured to determine the transportation demand information, based on the acquired number of to-be-transported objects.

In some alternative implementations of the present embodiment, the transportation demand information includes the driving route, and the driving status information includes the number of currently transported objects of the vehicle. The vehicle determining unit 503 may be further configured to: determine a vehicle whose number of currently transported objects in the vehicle formation being less than a first preset threshold as a pending vehicle; determine whether a driving route corresponding to the pending vehicle matches the driving route in the transportation demand information; and determine, in response to determining that the driving route corresponding to the pending vehicle matches the driving route in the transportation demand information, the target vehicle from the pending vehicle.

In some alternative implementations of the present embodiment, the transportation demand information includes a driving route, and the driving status information includes location information. The vehicle determining unit 503 may be further configured to: determine, based on the driving route in the transportation demand information and the location information of the vehicle in the vehicle formation, at least one vehicle corresponding to the location information having a shortest distance to the driving route that is less than a second preset threshold; and determine the target vehicle from the determined at least one vehicle.

In some alternative implementations of the present embodiment, the apparatus may further include a third acquisition unit not shown in FIG. 5, configured to acquire driving environment information of the vehicle in the vehicle formation. The vehicle determining unit 503 may be further configured to: determine the target vehicle from the vehicle formation based on the transportation demand information, the driving status information, and the acquired driving environment information.

The apparatus for controlling a vehicle provided by the above embodiment of the present disclosure implements automatic dispatch of a vehicle in a vehicle formation based on the transportation demand information and the driving status information, thereby improving vehicle use efficiency.

It should be understood that the units 501 to 504 described in the apparatus 500 for controlling a vehicle correspond to respective steps in the method described with reference to FIG. 2. Therefore, the operations and features described above with respect to the method for controlling a vehicle are also applicable to the apparatus 500 and the units included therein, and detailed description thereof will be omitted.

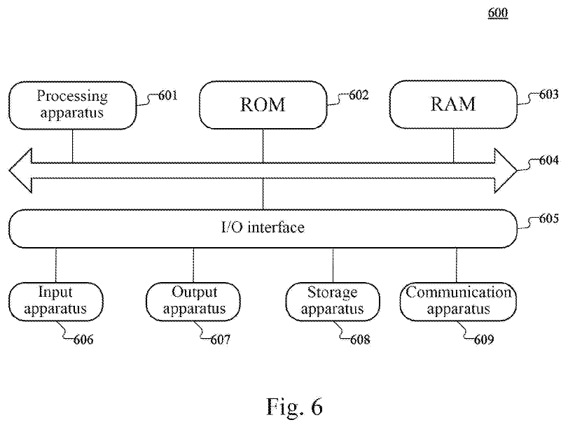

With further reference to FIG. 6, which shows a schematic structural diagram of an electronic device (such as the server in FIG. 1) 600 suitable for implementing embodiments of the present disclosure. The electronic device shown in FIG. 6 is only an example, and should not bring any limitation to the functions and use scope of the embodiments of the present disclosure.

As shown in FIG. 6, the electronic device 600 may include a processing apparatus (e.g., a central processing unit or a graphics processing unit) 601, which may execute various appropriate actions and processes in accordance with a program stored in a read-only memory (ROM) 602 or a program loaded into a random access memory (RAM) 603 from a storage apparatus 608. The RAM 603 also stores various programs and data required by operations of the electronic device 600. The processing apparatus 601, the ROM 602 and the RAM 603 are connected to each other through a bus 604. An input/output (I/O) interface 605 is also connected to the bus 604.

Usually, the following apparatuses are connected to the I/O interface 605: an input apparatus 606 including, for example, a touch screen, a touch pad, a keyboard, a mouse, a camera, a microphone, an accelerometer and a gyroscope; an output apparatus 607 including, for example, a liquid crystal display (LCD), a speaker and a vibrator; a storage apparatus 608 including, for example, a magnetic tape and a hard disk; and a communication apparatus 609. The communication apparatus 609 may allow the electronic device 600 to exchange data through a wireless communication or a wired communication with other devices. Although FIG. 6 illustrates the electronic device 600 having various apparatuses, it should be understood that it is not required to implement or possess all of the illustrated apparatuses. More or less apparatuses may be alternatively implemented or possessed. Each of the blocks shown in FIG. 6 may represent one apparatus, or may represent a plurality of apparatuses as required.

In particular, according to embodiments of the present disclosure, the process described above with reference to the flow chart may be implemented in a computer software program. For example, an embodiment of the present disclosure includes a computer program product, which includes a computer program that is tangibly embedded in a machine-readable medium. The computer program includes program codes for executing the method as illustrated in the flow chart. In such an embodiment, the computer program may be downloaded and installed from a network via the communication apparatus 609, or may be installed from the storage apparatus 608, or may be installed from the ROM 602. The computer program, when executed by the processing apparatus 601, implements the functions as defined by the methods of the present disclosure. It should be noted that the computer readable medium in the present disclosure may be computer readable signal medium or computer readable storage medium or any combination of the above two. An example of the computer readable storage medium may include, but not limited to: electric, magnetic, optical, electromagnetic, infrared, or semiconductor systems, apparatus, elements, or a combination of any of the above. A more specific example of the computer readable storage medium may include but is not limited to: electrical connection with one or more wire, a portable computer disk, a hard disk, a random access memory (RAM), a read only memory (ROM), an erasable programmable read only memory (EPROM or flash memory), a fibre, a portable compact disk read only memory (CD-ROM), an optical memory, a magnet memory or any suitable combination of the above. In the present disclosure, the computer readable storage medium may be any tangible medium containing or storing programs which may be used by a command execution system, apparatus or element or incorporated thereto. In the present disclosure, the computer readable signal medium may include data signal in the base band or propagating as parts of a carrier, in which computer readable program codes are carried. The propagating data signal may take various forms, including but not limited to: an electromagnetic signal, an optical signal or any suitable combination of the above. The signal medium that can be read by computer may be any computer readable medium except for the computer readable storage medium. The computer readable medium is capable of transmitting, propagating or transferring programs for use by, or used in combination with, a command execution system, apparatus or element. The program codes contained on the computer readable medium may be transmitted with any suitable medium including but not limited to: wireless, wired, optical cable, RF medium etc., or any suitable combination of the above.

The computer readable medium may be included in the server, or a stand-alone computer readable medium not assembled into the electronic device. The computer readable medium carries one or more programs. The one or more programs, when executed by the electronic device, cause the electronic device to: acquire transportation demand information; acquire driving status information of a vehicle in a vehicle formation; determine a target vehicle from the vehicle formation based on the transportation demand information and the driving status information; and send a dispatch instruction to the target vehicle, so that the target vehicle executes a transportation task indicated by the transportation demand information according to the dispatch instruction.

A computer program code for executing operations in the present disclosure may be compiled using one or more programming languages or combinations thereof. The programming languages include object-oriented programming languages, such as Java, Smalltalk or C++, and also include conventional procedural programming languages, such as “C” language or similar programming languages. The program code may be completely executed on a user's computer, partially executed on a user's computer, executed as a separate software package, partially executed on a user's computer and partially executed on a remote computer, or completely executed on a remote computer or server. In the circumstance involving a remote computer, the remote computer may be connected to a user's computer through any network, including local area network (LAN) or wide area network (WAN), or may be connected to an external computer (for example, connected through Internet using an Internet service provider).

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion comprising one or more executable instructions for implementing specified logic functions. It should also be noted that, in some alternative implementations, the functions denoted by the blocks may occur in a sequence different from the sequences shown in the figures. For example, any two blocks presented in succession may be executed, substantially in parallel, or they may sometimes be in a reverse sequence, depending on the function involved. It should also be noted that each block in the block diagrams and/or flow charts as well as a combination of blocks may be implemented using a dedicated hardware-based system executing specified functions or operations, or by a combination of a dedicated hardware and computer instructions.

The units involved in the embodiments of the present disclosure may be implemented by means of software or hardware. The described units may also be provided in a processor, for example, may be described as: a processor including a first acquisition unit, a second acquisition unit, a vehicle determining unit, and an instruction sending unit. Here, the names of these units do not in some cases constitute limitations to such units themselves. For example, the first acquisition unit may also be described as “a unit configured to acquire transportation demand information”.

The above description only provides an explanation of the preferred embodiments of the present disclosure and the technical principles used. It should be appreciated by those skilled in the art that the inventive scope of the present disclosure is not limited to the technical solutions formed by the particular combinations of the above-described technical features. The inventive scope should also cover other technical solutions formed by any combinations of the above-described technical features or equivalent features thereof without departing from the concept of the disclosure. Technical schemes formed by the above-described features being interchanged with, but not limited to, technical features with similar functions disclosed in the present disclosure are examples.

1. A method for controlling a vehicle, comprising the steps of:
acquiring transportation demand information;
acquiring driving status information of a vehicle in a vehicle formation;
determining a target vehicle from the vehicle formation based on the transportation demand information and the driving status information; and
sending a dispatch instruction to the target vehicle, to cause the target vehicle to execute a transportation task indicated by the transportation demand information according to the dispatch instruction.

2. The method according to claim 1, wherein the vehicle in the vehicle formation travels on a driving route corresponding to the vehicle, and the driving route comprises a plurality of stations; and
the acquiring transportation demand information, comprises:
acquiring a number of to-be-transported objects at each station in the driving route, for the driving route corresponding to the vehicle in the vehicle formation;
determining the transportation demand information, based on the acquired number of to-be-transported objects.

3. The method according to claim 2, wherein the transportation demand information comprises the driving route, and the driving status information comprises a number of currently transported objects of the vehicle; and
the determining a target vehicle from the vehicle formation based on the transportation demand information and the driving status information, comprises:
determining a vehicle whose number of currently transported objects in the vehicle formation being less than a first preset threshold as a pending vehicle;
determining whether a driving route corresponding to the pending vehicle matches the driving route in the transportation demand information; and
determining, in response to determining that the driving route corresponding to the pending vehicle matches the driving route in the transportation demand information, the target vehicle from the pending vehicle.

4. The method according to claim 1, wherein the transportation demand information comprises a driving route, and the driving status information comprises location information; and
the determining a target vehicle from the vehicle formation based on the transportation demand information and the driving status information, comprises:
determining, based on the driving route in the transportation demand information and the location information of the vehicle in the vehicle formation, at least one vehicle corresponding to the location information having a shortest distance to the driving route that is less than a second preset threshold; and
determining the target vehicle from the determined at least one vehicle.

5. The method according to claim 1, wherein the method further comprises:
acquiring driving environment information of the vehicle in the vehicle formation; and
the determining a target vehicle from the vehicle formation based on the transportation demand information and the driving status information, comprises:
determining the target vehicle from the vehicle formation based on the transportation demand information, the driving status information, and the acquired driving environment information.

6. An apparatus for controlling a vehicle, comprising:
at least one processor; and
a memory storing instructions, wherein the instructions when executed by the at least one processor, cause the at least one processor to perform operations, the operations comprising:
acquiring transportation demand information;
acquiring driving status information of a vehicle in a vehicle formation;
determining a target vehicle from the vehicle formation based on the transportation demand information and the driving status information; and
sending a dispatch instruction to the target vehicle, to cause the target vehicle execute a transportation task indicated by the transportation demand information according to the dispatch instruction.

7. The apparatus according to claim 6, wherein the vehicle in the vehicle formation travels on a driving route corresponding to the vehicle, and the driving route comprises a plurality of stations; and
the acquiring transportation demand information, comprises:
acquiring a number of to-be-transported objects at each station in the driving route, for the driving route corresponding to the vehicle in the vehicle formation;
determining the transportation demand information, based on the acquired number of to-be-transported objects.

8. The apparatus according to claim 7, wherein the transportation demand information comprises the driving route, and the driving status information comprises a number of currently transported objects of the vehicle; and
the determining a target vehicle from the vehicle formation based on the transportation demand information and the driving status information, comprises:
determining a vehicle whose number of currently transported objects in the vehicle formation being less than a first preset threshold as a pending vehicle;
determining whether a driving route corresponding to the pending vehicle matches the driving route in the transportation demand information; and
determining, in response to determining that the driving route corresponding to the pending vehicle matches the driving route in the transportation demand information, the target vehicle from the pending vehicle.

9. The apparatus according to claim 6, wherein the transportation demand information comprises a driving route, and the driving status information comprises location information; and
the determining a target vehicle from the vehicle formation based on the transportation demand information and the driving status information, comprises:
determining, based on the driving route in the transportation demand information and the location information of the vehicle in the vehicle formation, at least one vehicle corresponding to the location information having a shortest distance to the driving route that is less than a second preset threshold; and
determining the target vehicle from the determined at least one vehicle.

10. The apparatus according to claim 6, wherein the operations further comprise:
acquiring driving environment information of the vehicle in the vehicle formation; and
the determining a target vehicle from the vehicle formation based on the transportation demand information and the driving status information, comprises:
determining the target vehicle from the vehicle formation based on the transportation demand information, the driving status information, and the acquired driving environment information.

11. (canceled)

12. A non-transitory computer readable medium, storing a computer program thereon, the program, when executed by a processor, implements the method according to claim 1.

13. The method according to claim 2, wherein the method further comprises:
acquiring driving environment information of the vehicle in the vehicle formation; and
the determining a target vehicle from the vehicle formation based on the transportation demand information and the driving status information, comprises:
determining the target vehicle from the vehicle formation based on the transportation demand information, the driving status information, and the acquired driving environment information.

14. The method according to claim 3, wherein the method further comprises:
acquiring driving environment information of the vehicle in the vehicle formation; and
the determining a target vehicle from the vehicle formation based on the transportation demand information and the driving status information, comprises:
determining the target vehicle from the vehicle formation based on the transportation demand information, the driving status information, and the acquired driving environment information.

15. The method according to claim 4, wherein the method further comprises:
acquiring driving environment information of the vehicle in the vehicle formation; and
the determining a target vehicle from the vehicle formation based on the transportation demand information and the driving status information, comprises:
determining the target vehicle from the vehicle formation based on the transportation demand information, the driving status information, and the acquired driving environment information.
